(19) United States
(12) Patent Application Publication
(10) Pub. No.: US 2010/0275120 A1
(43) Pub. Date: Oct. 28, 2010

(54) PROCESSING OF FIELDS IN MOTION PICTURE VIDEOS OR STILL PHOTOS

(76) Inventor: Nicholas Pappas, Succasunna, NJ (US)

Correspondence Address: WALTER J. TENCZA JR., 100 Menlo Park, Suite 210, Edison, NJ, 08837, US

(21) Appl. No.: 12/427,800

(22) Filed: Apr. 22, 2009

(51) Int. Cl. G06F 3/048

(52) U.S. Cl. 715/716

(57) ABSTRACT

A computer processor receives a selection of a link field displayed on a computer monitor in a motion picture video or in a still digital image on the computer monitor. The computer processor may be programmed to determine if the link field relates to setting up an interactive conference, activating a first motion picture video, activating a first digital still photograph, or activating a first audio clip. The computer processor may be programmed, such that if the link field relates to an interactive conference, activating a first motion picture video, activating the first digital still photograph, or activating the first audio clip, the computer processor takes appropriate action in response to the selection of the link field.

### FIELD OF THE INVENTION

This invention relates to improved methods and apparatus concerning processing of fields which can be selected on a computer screen of a computer monitor.

### BACKGROUND OF THE INVENTION

There are various devices known in the prior art related to processing of fields on a computer screen of a computer monitor.

### SUMMARY OF THE INVENTION

One or more embodiments of the present invention include a method comprising receiving a selection of a link field displayed on a computer monitor, determining by use of a computer processor, if the link field relates to a voice internet protocol call, and if the link field relates to a voice internet protocol call, causing the computer processor to set up a voice internet protocol call in response to the selection of the link field. The link field may be displayed in a motion picture video or video clip on the computer monitor. The term motion picture video is used to distinguish a changing image on a computer screen from a still image on a computer screen. In another embodiment, the link field may be displayed in a still digital photograph on the computer monitor.

The method may also include determining by use of the computer processor, if the link field relates to an interactive conference. If the link field relates to an interactive conference, the method may include causing the computer processor to set up the interactive conference in response to the selection of the link field.

The method may include determining by use of the computer processor, if the link field relates to a activating a first motion picture video which is not currently being displayed on the computer monitor. If the link field relates to activating the first motion picture video, the method may include causing the computer processor to activate the first motion picture video in response to selection of the link field. The method may also include determining by use of the computer processor, if the link field relates to a activating a first still digital photograph which is not currently being displayed on the computer monitor. If the link field relates to activating the first still digital photograph, the computer processor may activate the first still digital photograph in response to selection of the link field.

The method may also include determining by use of the computer processor, if the link field relates to activating a first audio clip on a speaker device, wherein the first audio clip is not currently being run on the speaker device. If the link field relates to activating the first audio clip, the computer processor may activate the first audio clip on the speaker device in response to selection of the link field.

One or more embodiments of the present invention may also include an apparatus. The apparatus include a first user computer, which may be comprised of a user interactive device, a computer monitor, a computer processor, and a speaker device. The computer processor may be programmed to receive a selection of a link field displayed on the computer monitor. The computer processor may be programmed to determine if the link field relates to a voice Internet protocol call, and to cause a voice internet protocol to be set up in response to the selection of the link field. The computer processor may be programmed to display the link field in a video or motion picture on the computer monitor. The computer processor may be programmed to display the link field in a digital photograph on the computer monitor.

In one or more embodiments of the present invention, the computer processor may be programmed to determine if the link field relates to setting up an interactive conference, activating a first video, activating a first digital still photograph, or activating a first audio clip. The computer processor may be programmed, such that if the link field relates to an interactive conference, activating a first video, activating the first digital still photograph, or activating the first audio clip, the computer processor takes appropriate action in response to the selection of the link field.

### BRIEF DESCRIPTION OF THE DRAWINGS

FIG. 1 shows a diagram of an apparatus for use in accordance with an embodiment of the present invention;

FIG. 2 shows an image, which can be displayed on a computer screen of a computer monitor of the apparatus of FIG. 1;

FIG. 3 shows a flow chart of a method in accordance with an embodiment of the present invention;

FIG. 4 shows another image which may appear on a computer screen of a computer monitor of the apparatus of FIG. 1; and

FIG. 5 shows a flow chart of another method in accordance with another embodiment of the present invention.

### DETAILED DESCRIPTION OF THE DRAWINGS

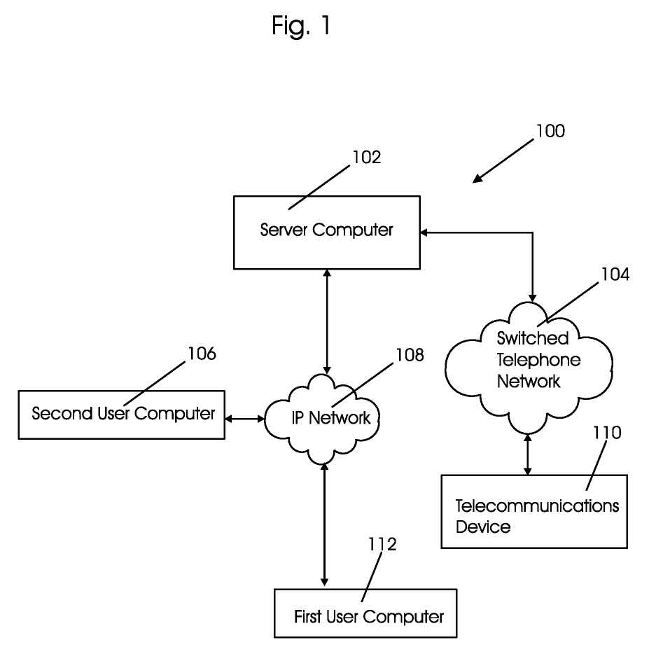

FIG. 1 shows a diagram of an apparatus 100 for use in accordance with an embodiment of the present invention. The apparatus 100 includes a server computer 102, a switched telephone network or traditional telephone network 104, a second user computer 106, an IP network 108, a telecommunications device 110, and a first user computer 112. Each of the server computer 102, first user computer 112, and the second user computer 106 may include a computer processor, a computer memory, a speaker device, a computer monitor, and a computer interactive device, such as a computer keyboard, computer mouse, and/or touch screen.

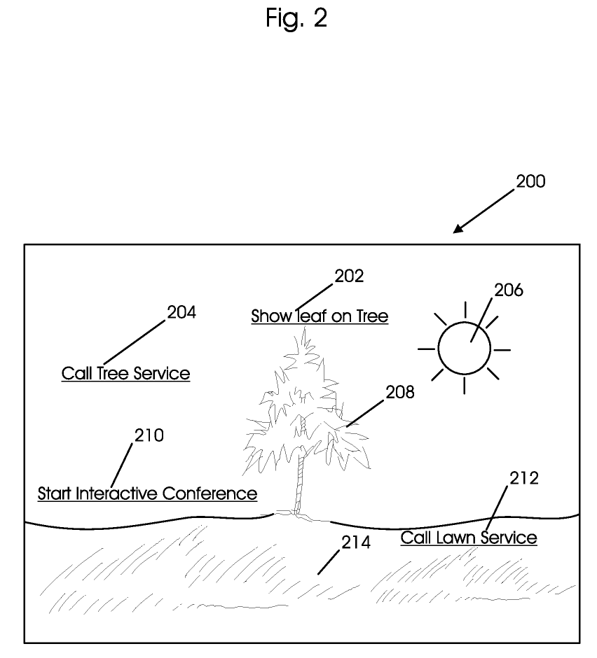

FIG. 2 shows an image 200 which can be displayed on a computer screen of a computer monitor of the first user computer 112 or the second user computer 106 in accordance with an embodiment of the present invention. The image 200 includes fields 202, 204, 206, 208, 210, and 212. The fields 202, 204, 210, and 212 show underlined words or text. The fields 206, 208, and 214 show graphics, symbols, or parts of motion picture video or still digital photos or photographs. Each of the fields 202, 204, 206, 208, 210, 212, and 214, when selected using a computer cursor controlled by a computer mouse or a computer touch screen, causes an action by a computer processor. For example, selecting field 204 for “Call Tree Service” on a computer monitor of the first user computer 112, may cause a computer processor of the first user computer 112, to set up a VOIP (Voice over internet protocol) phone call to the telecommunications device 110 (which may have a phone number of a company which cuts trees) via the IP (Internet Protocol) network 108, the server computer 102, and the switched telephone network 104. Similarly, selecting field 212 for “Call Lawn Service” on a computer monitor of the first user computer 112, may cause a computer processor of the first user computer 112, to set up a VOIP (Voice over internet protocol) phone call to a different telecommunications device, not shown, (which may have a phone number of a lawn service company, which may be different from the company which cuts trees) via the IP (Internet Protocol) network 108, the server computer 102, and the switched telephone network 104.

In addition, in at least one embodiment of the present invention, selecting the field 202 “Show Leaf on Tree”, on a computer monitor of the first user computer 112, may cause a computer processor of the first user computer 112, to display an image of a close up view of a single leaf from the tree shown in field 208 of FIG. 2. The image of the close up view of the single leaf may be displayed over the image 200 or instead of the image 200. A user may also select the field 208 or the image of the tree itself in image 200 in order to display an image of a close up view of the single leaf. Similarly, a user may select the field or image 206 of the sun, which may cause the computer processor of the first user computer to display a close up view of the sun or field 206 or may display some information about the sun 206. The close up view of the sun of field 206 or information about the sun of field 206 may be displayed over the image 200 in place of the image 200.

In addition, in at least one embodiment of the present invention, selecting the field 210 “Start Interactive Conference” causes a computer processor of the first user computer 112 to start an interactive conference with the second user computer 106 via the IP network 108.

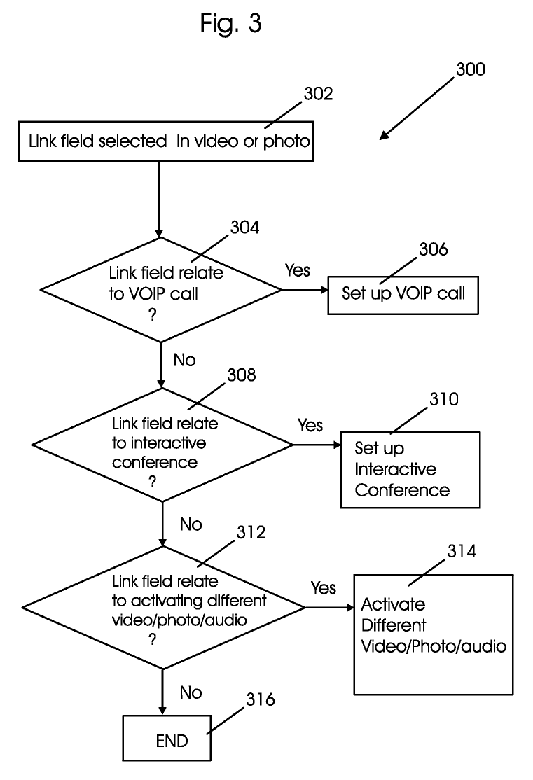

FIG. 3 shows a flow chart 300 of a method in accordance with an embodiment of the present invention. At step 302 a link field is selected in a motion picture video or still digital photograph on a computer screen of a computer monitor of a computer, such as first user computer 112 of FIG. 1. At step 304, a computer processor of a computer, such as first user computer 112, determines whether the link field relates to a VOIP call, such as link fields 204 and 212 of FIG. 2. A VOIP may be a call, which is at least partially transmitted from a computer, such as first user computer 112 over an IP network, such as IP network 108. The call may also be partially transmitted over a traditional telephone network, such as 104 in FIG. 1. For example, the first user computer 112 may transmit a VOIP call via IP network 108 to the server computer 102, and then the server computer 102 may cause a conventional non VOIP call or non VOIP part of the call, to be transmitted via the switched telephone network 104 to the telecommunications device 110. If the link field involves a VOIP call the call is setup at step 306, such as by a computer processor of the first user computer 112.

If this is not a VOIP call related link field, then at step 308 the computer processor, such as a computer processor of the first user computer 112, determines if the link field relates to an interactive conference, such as link field 210 of FIG. 2. If the link field relates to an interactive conference, then at step 310, a computer processor, such as a computer processor of the first user computer 112, sets up an interactive conference, such as with the second user computer 106 via IP network 108.

If the link field does not relate to an interactive conference, then it is determined whether the link field relates to activating a different motion picture video clip, still digital photo, or audio clip. For example field 202 may be selected on a computer monitor of the first user computer 112 to show a close up image of a leaf for the tree of field 208. Alternatively, or additionally, selecting on the field 208 may cause a computer processor of the first user computer 112 to cause an audio sound to be emitted from speakers of the first user computer 112, such as the audio sound of wind blowing through leaves on a tree. Selecting any of the fields 202, 206, 208, or 214 may cause different photos or motion picture videos to be displayed, which may overlay the image 200 of FIG. 2, or which may replace the image 200 of FIG. 2.

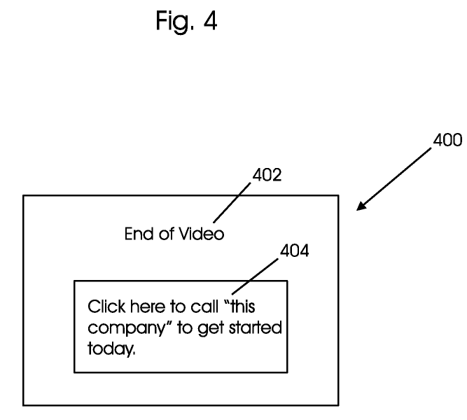

FIG. 4 shows an image 400 which may appear on a computer screen of a computer monitor of the apparatus 100 of FIG. 1. The image 400, may for example, appear on a computer screen of a computer monitor of the first user computer 112. The image 400 may be part of a motion picture video and may have an indication 402 that the end of the video has come, such as “End of Video”. The video may be a promotional motion picture video for a company or for a product of a company. The image 400 may include an indication 404 that a user should click on the indication or field 404 to place a phone call to the company.

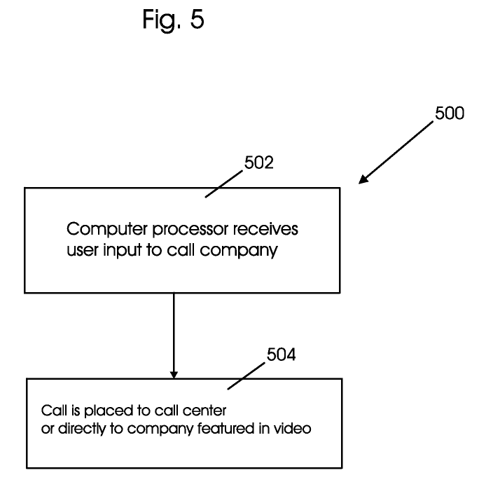

FIG. 5 shows a flow chart 500 of another method in accordance with another embodiment of the present invention. The flow chart 500 includes steps 502 and 504. Step 502 indicates that a computer processor, such as a computer processor of the first user computer 112 in FIG. 1, has received a user input to call the company, which is associated with the image 400 and the corresponding promotional motion picture video. The user input to call may be supplied by clicking a computer mouse of a computer interactive device of the first user computer 112. A computer processor of the first user computer 112 may respond to the user input of step 501 by placing a call to a call center or by placing a call directly to a company featured in the motion picture video, in step 504. The first user computer 112 may connect the user through IP network 108, through server computer 102, and through the switched telephone network to a telecommunications device or telephone of the company or call center. The first user computer 112 may also place an Internet phone call over IP network 108 to second user computer 106.

In one or more embodiments of the present invention when selected fields, indications or buttons, such as fields 202, 204, 206, 208, 210, 212, and 214 in FIG. 2, or field or indication 404 in FIG. 4 perform a call or other action. The action can be bringing up additional detail on a computer monitor of a user computer, such as first user computer 112, bringing up an interactive form on the first user computer 112 or getting a live person via VoIP (Voice Internet Protocol) or traditional phone line (POTS—plain old telephone service).

The action can be initiated by several interactive means or interactive devices which may be part of first user computer 112 shown by FIG. 1, including but not limited to physical touch of a computer monitor of first user computer 112, voice recognition device of first user computer 112, contact by a device, pointer, RFID (radio frequency identification) or physical body movement or gesture detected by devices such as a camera or other motion detection device which may be part of a user interactive device of first user computer 112.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
receiving a selection of a link field displayed on a computer monitor;
determining by use of a computer processor, if the link field relates to a voice Internet protocol call; and
if the link field relates to a voice Internet protocol call, causing the computer processor to set up a voice Internet protocol call in response to the selection of the link field.

2. The method of claim 1 wherein
the link field is displayed in a motion picture video on the computer monitor.

3. The method of claim 1 wherein
the link field is displayed in a still digital photograph on the computer monitor.

4. The method of claim 1 further comprising
determining by use of the computer processor, if the link field relates to an interactive conference;
and if the link field relates to an interactive conference, causing the computer processor to set up the interactive conference in response to the selection of the link field.

5. The method of claim 1 further comprising
determining by use of the computer processor, if the link field relates to activating a first motion picture video, which is not currently being displayed on the computer monitor;
and if the link field relates to activating the first motion picture video, causing the computer processor to activate the first motion picture video in response to selection of the link field.

6. The method of claim 1 further comprising
determining by use of the computer processor, if the link field relates to a activating a first still digital photograph, which is not currently being displayed on the computer monitor;
and if the link field relates to activating the first still digital photograph, causing the computer processor to activate the first still digital photograph in response to selection of the link field.

7. The method of claim 1 further comprising
determining by use of the computer processor, if the link field relates to a activating a first audio clip on a speaker device, which is not currently being run on the speaker device;
and if the link field relates to activating the first audio clip, causing the computer processor to activate the first audio clip on the speaker device in response to selection of the link field.

8. An apparatus comprising
a user interactive device;
a computer monitor; and
a computer processor;
wherein the computer processor is programmed to receive a selection of a link field displayed on the computer monitor;
wherein the computer processor is programmed to determine if the link field relates to a voice Internet protocol call; and
wherein the computer processor is programmed, such that if the link field relates to a voice Internet protocol call, the computer processor causes a voice Internet protocol to be set up in response to the selection of the link field.

9. The apparatus of claim 8 wherein
the computer processor is programmed to display the link field in a motion picture video on the computer monitor.

10. The apparatus of claim 8 wherein
the computer processor is programmed to display the link field in a still digital photograph on the computer monitor.

11. The apparatus of claim 8 wherein
the computer processor is programmed to determine if the link field relates to an interactive conference;
and the computer processor is programmed, such that if the link field relates to an interactive conference, the computer processor sets up the interactive conference in response to the selection of the link field.

12. The apparatus of claim 8 wherein
the computer processor is programmed to determine if the link field relates to a activating a first motion picture video, which is not currently being displayed on the computer monitor;
and if the link field relates to activating the first motion picture video, the computer processor activates the first motion picture video in response to selection of the link field.

13. The apparatus of claim 8 wherein
the computer processor is programmed to determine if the link field relates to a activating a first still digital photograph, which is not currently being displayed on the computer monitor;
and the computer processor is programmed, such that if the link field relates to activating the first still digital photograph, the computer processor activates the first still digital photograph in response to selection of the link field.

14. The apparatus of claim 8 further wherein
the computer processor is programmed to determine if the link field relates to a activating a first audio clip on a speaker device, wherein the first audio clip is not currently being run on the speaker device;
and the computer processor is programmed, such that if the link field relates to activating the first audio clip, the computer processor activates the first audio clip on the speaker device in response to selection of the link field.
